(19) United States
(12) Patent Application Publication
(10) Pub. No.: US 2016/0275422 A1
(43) Pub. Date: Sep. 22, 2016

(54) FLOW MEASUREMENT-BASED TRANSACTIONAL FRAMEWORK

(71) Applicant: Microsoft Technology Licensing, LLC, Redmond, WA (US)

(72) Inventors: Xavier Chape, Copenhagen (DK); Arthur Greef, Burien, WA (US); Michael Gall, Copenhagen (DK); Bo Kampmann, Copenhagen (DK)

(21) Appl. No.: 14/801,251

(22) Filed: Jul. 16, 2015

Related U.S. Application Data
(60) Provisional application No. 62/133,752, filed on Mar. 16, 2015.

(51) Int. Cl. G06Q 10/06; G06Q 40/00

(52) U.S. Cl. CPC G06Q 10/067; G06Q 40/12

(57) ABSTRACT

A computer system for modelling transactions is provided that includes a processor a data store coupled to the processor. The data store containing a plurality of cost object models and a plurality of cost elements. The processor is configured to receive an indication of a cost event and flow an aspect of the cost event through at least one cost object stored in the data store.

### CROSS-REFERENCE TO RELATED APPLICATION

The present application is based on and claims the benefit of U.S. provisional patent application Ser. No. 62/133,752, filed Mar. 16, 2015, the content of which is hereby incorporated by reference in its entirety.

### BACKGROUND

Transactional systems, such as electronic accounting systems, may track data associated with various transactions and may characterize the transaction using multiple sets of attributes and dimensions that describe various characteristics at different levels of detail. For instance, a transaction for quantity of received goods may be characterized by attributes such as: the item number received and eventual item classification, a site, a warehouse and rack location where the quantity is received and stored, a number of units of the quantity received, and the date when goods become available in stock.

The discussion above is merely provided for general background information and is not intended to be used as an aid in determining the scope of the claimed subject matter.

### SUMMARY

A computer system for modelling transactions is provided that includes a processor a data store coupled to the processor. The data store containing a plurality of cost object models and a plurality of cost elements. The processor is configured to receive an indication of a cost event and flow an aspect of the cost event through at least one cost object stored in the data store.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a transactional system with which embodiments described herein are particularly useful.

FIG. 2 is a system block view of transactional system implemented as a cost accounting system in accordance with one embodiment.

FIG. 3 is a diagrammatic view of a cost accounting classification model in accordance with one embodiment.

FIG. 4 is a diagrammatic view of the flow of resources and value into and out of an organization, modeled in accordance with embodiments described herein.

FIG. 5 is a diagrammatic view of an organization's value chain and object definitions in accordance with embodiments described herein.

FIG. 6 is a diagrammatic view of cost object balances and settlement in accordance with embodiments described herein.

FIG. 7 is a diagrammatic view of a transactional system in accordance with the embodiments described herein modeling a cost accounting system of an organization.

FIG. 8 illustrates a series of operations that are registered in a value chain of an organization from an operational standpoint on an item stored at a warehouse.

FIG. 9 is a diagrammatic view of a computing environment in which a transactional system can be deployed in accordance with one embodiment.

### DETAILED DESCRIPTION

Embodiments described herein generally provide a system and methods for a generic and extensible sub ledger cost accounting framework in a data processing system. The framework, purposed for cost accounting activities in an organization's value chain, operates on measurements of cost classified per cost elements, flowing through abstracted cost objects. The framework also includes a set of patterns and procedures that action discrete methods, governed by policies, to regulate the cost flow measurements.

Conventional transactional systems have a number of limitations. For example, conventional cost accounting systems have distinctive data processing logic to account for movement of stocks and inventories cost, conversions process activities and cost of goods manufactured, overheads and absorption of indirect cost. This limitation results in a specific data model and relatively low code re-use across the transactional system's functionalities. Further, yet additional code may be required to collect, synthesize and aggregate data. This translates to complex maintenance and poor extensibility of such conventional systems.

Another limitation of conventional accounting systems is the number of industries and organizational layouts that are supported. This affects the ability of conventional transactional system solutions to meet requirements beyond their initial intended scope, whether in term of industries or organization, without significant investment and rewrite of code. For instance, a solution directed toward discrete manufacturing industries will require custom development to meet and conform to service industry needs.

Another limitation of conventional cost accounting systems is that they are generally designed with a limited set of attributes available for cost traceability. Enabling additional attributes, not initially built in, to meet specialized or custom requirements would require extensive development. For example, a manufacturing industry-oriented solution that supports cost accounting inventory per product only would require significant code additions and modifications to enable cost accounting inventory on a combination of project or market and product attributes, for example.

Another limitation of conventional cost accounting solutions is that they are primarily designed toward meeting statutory and financial reporting needs. Such solutions offer limited support for multiple inventory valuation, but fail to address cost accounting concurrently occurring with activities under significantly different cost accounting systems. For example, conventional cost accounting solutions may allow concurrent valuation of inventory under normal and standard absorption costing, but will not support concurrent Activity-Based Costing (ABC), marginal or throughput accounting along with absorption costing. This affects the ability of such solutions to satisfy both financial statutory and management accounting requirements.

Another limitation of conventional cost accounting systems is that such systems generally have built-in technical dependencies preventing such systems from decoupling the cost accounting logic from operations and ledger logic. This prevents such conventional cost accounting solutions from operating as an independent service provider and hampers adaptation of the solution to available cloud technologies.

Embodiments described herein generally provide a system and methods for a generic and extensible sub ledger cost accounting framework in a data processing system. The framework, purposed for cost accounting activities in an organization's value chain, operates on measurements of cost classified per cost elements, flowing through abstracted cost objects. The framework also includes a set of patterns and procedures that action discrete methods, governed by policies, to regulate the cost flow measurements. The policies regulating the cost flow are expressed and conditioned on the abstracted cost objects and cost elements. This allows the framework the flexibility to operate in conformity with a desired cost accounting system. The framework provides consistency in cost accounting regardless of the nature of cost, cost objects, operations and organization involved. The framework provides an easily extensible design by allowing addition of localized discrete methods, and allows cost accounting functionalities to operate as a service provider in the cloud.

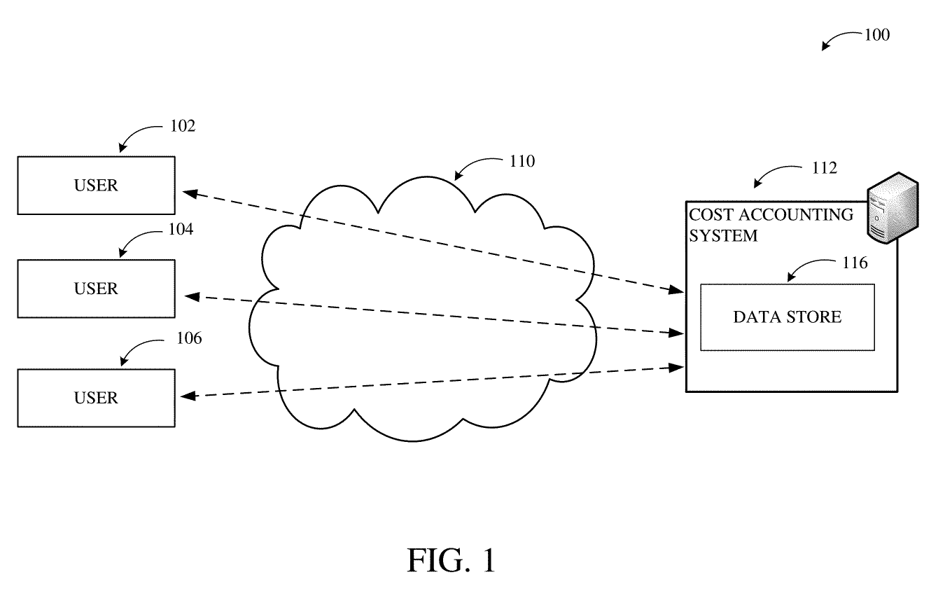

FIG. 1 is a diagrammatic view of a transactional system with which embodiments described herein are particularly useful. In particular, FIG. 1 illustrates an example of a cloud-based environment where a transactional data system may be implemented, according to some embodiments. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of environment 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, et cetera.

Environment 100 includes a transactional data system, such as cost accounting system 112, which may be accessed by multiple users (e.g. users 102, 104, 106) over a network, such as a wide area network 110. An example of cost accounting system 112 may provide tracking, recording, and retention or storage of data associated with an entity, organization, or system, such as a business enterprise. In the illustrated embodiment, cost accounting system is provided as a cloud-hosted application to an organization, and may be provided over network 110. Additionally, embodiments also include operating cost accounting system 112 locally on one or more computing devices of the organization such that it may be accessed locally and interacted with as a locally-installed application.

Some example transactions that may be tracked and retained by cost accounting system 112 may include financial transactions such as orders, invoices, payments, and accounting transactions. The transactions may be received from one or more source documents such as a purchase order, an invoice, a receipt, a shipping order, a receiving report, and an inventory list, and characterized in one or more dimensions. The source documents may be provided to cost accounting system 112 by the users (e.g. users 102, 104, 106) through a document entry interface that provides data entry fields or via a web-browser enabled form that accepts data entry and enables indirect and/or direct access to the source document by the cost accounting system 112. Recorded transactions may be stored in a data store 116 associated with cost accounting system 112. Data store 116 may enable retention of raw data associated with transactions, and may also store transaction documents associated with various tracked transactions to enable data accessibility and analysis. Data store 116 may store the data, for example, in tables, databases, lists, text files, or any other suitable data format for cost accounting system 112.

Multidimensional characterized data may be used in the determination of a magnitude of product cost and a product quantity. The magnitude of product cost and product quantity may be derived using one or more scales of units of measure that may be applied to cost accounting in one or more ledgers of cost accounting system 112. The defined scales may enable uniform multidimensional measurements to be used throughout the cost accounting system 112 as data associated with the transactions is transferred from the source documents, to event chains, to a sub-ledger journal and to a general ledger to be characterized and quantified. The general ledger may generate comprehensive data reports for data analysis, such as cost reports for cost analysis, based on the transaction data using the uniform multidimensional measurements, which may assist in meeting reporting regulation requirements. For example, using uniform multidimensional measurements may enable traceability from a transactional event at the source documents to its cost characterized and quantified in the general ledger.

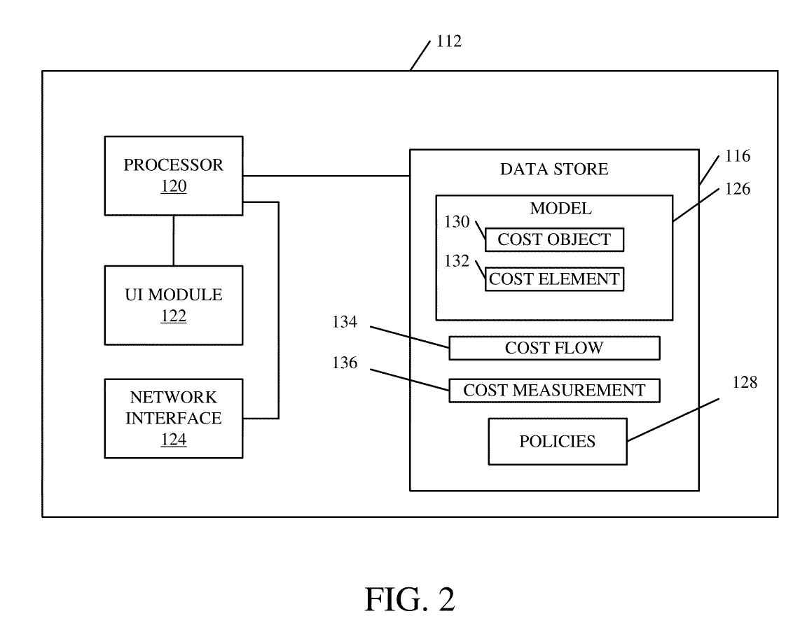

FIG. 2 is a system block view of cost accounting system 112, in accordance with one embodiment. System 112 includes processor 120 coupled to data store 116. Processor 120 may include one or more suitable microprocessors that are able to execute instructions stored in computer readable storage medium to perform various functions of system 112. Processor 120 is also coupled to user interface module 122 such that system 112 can provide suitable user interfaces, such as forms, reports, et cetera to users of system 112, either locally, or via network interface 124. Network interface 124 may be any suitable arrangement of circuitry that allows system 112 to communicate over one or more data communication networks. For example, network interface 124 may allow communication over a data communication network in accordance with the Ethernet protocol. Data store 116 includes, in one embodiment, model store 126 and policies store 128. Model store 126 includes cost object models 130 that define the various cost objects of system 112. Additionally, model store 126 includes cost elements 132 which set forth the various cost elements employed with system 112. Data store 116 also contains information related to cost flows 134 and cost measurements 136. Finally, policies store 128 stores the various policies of system 112, which regulate framework patterns and action discrete methods, conditioned on abstracted cost objects and cost elements, to conform and support custom cost accounting system functionalities that an organization may require.

Embodiments described herein generally provide a cost classification model that defines cost element units nominal scale in a multilevel, parent-child hierarchy. Each cost element unit (denoted CE) abstracts a level of classification for the value of cost flow, and categorization (for example, recognized/expired/material/labor/indirect et cetera) cascading down to child units. This results in cost classification policies that define the cost element unit defining and conditioning attributes. Additionally, the cost classification policies condition and provide methods related to cost element derivation. In one example, a cost classification model may be defined for classification on recognition of a cost event to resolve a cost element according to a cost group associated with a procured item. On expiration, the recognized cost element may be preserved but the cost may be classified as either a variance and its sub-type or as a value delivered to a consumer.

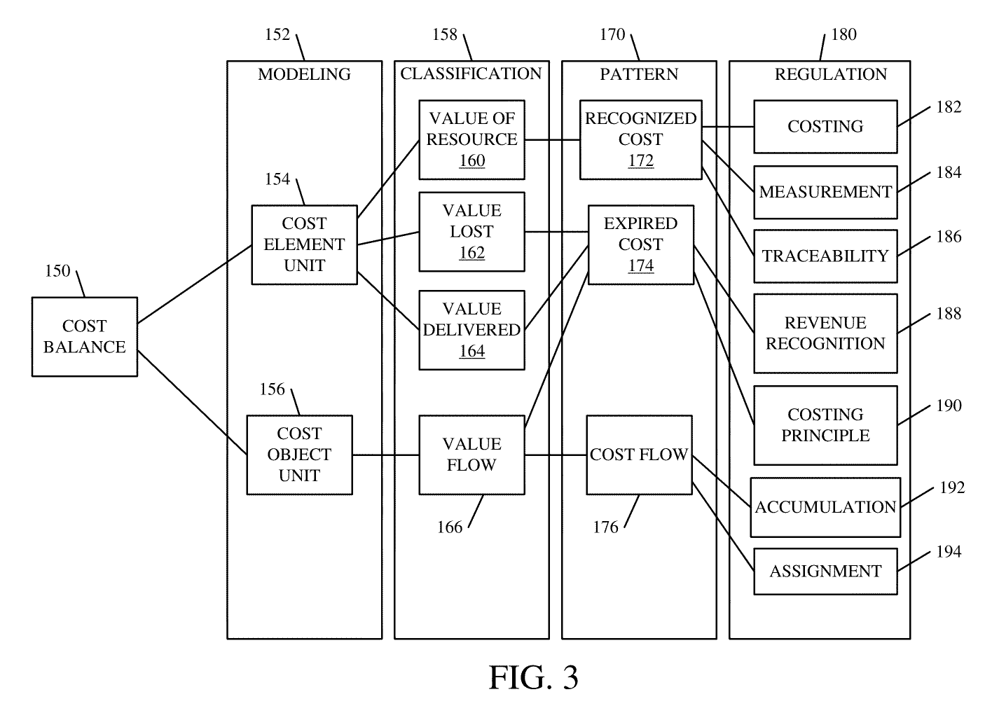

FIG. 3 is a diagrammatic view of a cost accounting classification model in accordance with one embodiment. As shown in FIG. 3, a number of patterns 170 and classifications 158 with respect to costs are provided. In the example, a cost balance 150 can be modeled, as indicated in modeling column 152, as a cost element unit 154 that classifies the value of a resource as well as a cost object unit 156 that models a segment of the value chain for the organization. For each modeled object or unit, one or more classifications 158 may be applicable. For example, cost element unit 154 may be classified to indicate the value of a resource 160, a value lost, 162, and/or a value delivered, 164. Additionally, cost object 156 is generally classified to provide a value flow, as indicated at reference numeral 166.

Embodiments described herein generally provide cost accounting patterns 170 that are able to recognize cost, expire cost, and appropriately model cost flow (inflow/outflow). For example, value of resource classification 160 is linked to recognized cost pattern 172. Value lost classification 162, value delivered classification 164, and value flow classification 166 are all potentially applicable to expired cost pattern 174. Further, value flow classification 166 is also applicable to cost flow pattern 176. As shown in FIG. 3, a number of regulations 180 are applicable to the various patterns 170. For example, recognized cost pattern 172 is potentially applicable to costing regulation 182, measurements regulation 184, and traceability regulation 186. Further, expired cost pattern 174 is applicable to revenue recognition regulation 188 and costing principle regulation 190. Finally, cost flow pattern 176 is potentially applicable to accumulation regulation 192 and assignment regulation 194.

As set forth above, the cost control model defines a cost object unit(s) nominal scale in the multilevel parent-child hierarchy. Each cost object unit 156 abstracts a level of segmentation of the organization(s) value chain and characterizes its role (for example, inventory, conversion, sales, support) on which applicable cost flow regulation policies 180, eventually inherited from parent level units, are expressed. The cost flow regulation policies fall into multiple categories. For example, cost accumulation policy 192 regulates cost flow on benefit and inflow patterns. These patterns define cost object units' defining attributes value combinations. Further, the cost accumulation policy 192 identifies units and their level in the scale. The cost accumulation policy 192 also determines the rule, for example, the condition and method for derivation of a cost object. Further, cost accumulation policy 192 also defines the cost flow identifiers defining attributes (for example, batch, serial number, operation number, et cetera). Cost accumulation policy 192 also identifies the occurrence of flow and its defining attributes. For example, the conditions that identify the flow may satisfy a rule and provide a method for derivation of a cost flow identifier. The cost flow identifier identifies a costing method (actual, normal standard cost). This governs the method for measuring cost contributions per class of cost element. Further, cost accumulation policy 192 provides a rule and formula for determining applied unit cost, as appropriate.

Regulations 180 also include cost assignment policy 194 which regulates cost flow for outflow and sacrifice patterns. Cost assignment policy 194 defines traceability and/or joint allocation methods (direct tracing, indirect tracing, driver tracing, et cetera). This policy also governs the basis for distributing assigned cost and provides a rule and formula for determining applied basis. Further, assignment policy 194 defines an assignment cost method that may include, for example, flow assumption (First In First Out (FIFO), Last In First Out (LIFO), average, specific). Further, assignment policy 194 may also define the reporting periodicity of cost object balance (perpetual, periodic, deferred, et cetera). The cost assignment policy 194 may also define estimations of cost (planned, budgeted, estimated, average, et cetera). Further, cost assignment policy 194 may provide a rule that allows for the conditions and calculation of applied unit cost.

The following are illustrative policies, expressed in cost accounting domain terminology, to help illustrate the relationship and governing cost accounting notions that regulate cost flow. For example, the following cost control model may be defined, for cost control and cost flow regulation. Note, this is only a simplified example meant to illustrate various principles described herein. In the example, the model is defined to determine a role of an organization segment (inventory or sales) in a value chain and per item and site. In the example, a policy is also set to be a standard cost perpetual policy that assigns costs using direct traceability on all represented objects. The concepts and derived method of using generic formulas for derivation of cost flow measurements magnitudes, where the determination of [Applied Basis] and [Applied Unit cost] are applicable operands are governed through policies. In the table below operands [underlines in brackets] designate a balance of measurements obtained using criteria and methods defined and conditioned through policies. The notation [Measure] [Dimension] in formulas denote a multidimensional measure.

| Measure type | Magnitude Formula |
|---|---|
| Cost resource flow | [Input Basis][co] = [Applied |
| | Basis][co] + [Quantity |
| | deviation][co] |
| Cost flow contribution | [Input value][ce]= [Applied |
| | cost][ce] + [Price deviation][ce] + |
| | [Quantity deviation][ce] + |
| | [Substitution deviation][ce] |
| | Where : |

| . | [Applied cost][co*ce] |
|---|---|
| = [Applied basis][co]*[Applied unit | |
| cost][ce] | |
| . | [Price deviation][co*ce] = |
| [Input Basis ][co]*( [Input value | |
| ][co*ce] / ([Applied Basis ][co] − | |
| [Applied unit cost][co] ) | |
| . | [Quantity deviation][co*ce] =( |
| [Input Basis ][co] − [Applied | |
| Basis][co])* [Applied unit cost][ce] | |
| . | [Substitution deviation][co*ce] |

=[Input value][co*ce] − [Applied
cost][co*ce]−[Price
deviation][co*ce] − [quantity
deviation][co*ce]

Patterns 170 are, in one embodiment, reusable and enforce principles for producing cost flow measurements and their relationships with the economic consequences of an operation event. Such relationships typically fall into three main types of categories. Such categories include cost flow relationship, reconciliation relationship, and settlement relationship.

A cost flow relationship enforces the principle that cost flow measurements are required to relate to the cost flow identifier to which they contribute.

A reconciliation relationship relates a reconciling cost event to a reconciled cost event for a reconciliation magnitude, where the reconciliation magnitude will participate to the formula's operand determination for computing the reconciling cost event measurement magnitudes.

A settlement relationship relates a cost object's cost assignment flow to cost accumulated flow for a magnitude. A settlement magnitude documents the portion of accumulated cost settled to establish the cost assignment cost.

Reconciliation and settlement relationships conform to the principles where a magnitude can reconcile/settle up to the un-reconciled/un-settled balance, but no more. Reconciled/un-reconciled and settled/un-settled balances are important providers of formula operands. Note, that both reconciliation and settlement relationships can be conceived as measurements. For simplification they will not be represented as such and the reconciliation magnitude is represented as dimensionless factor.

The patterns 170, themselves, are generally provided in the form a pre-defined set of measurements to be populated according to the principles enforced on the pattern. The principles are generally selected to apply for establishing relationships. The sources of the operands generally apply to a formula. The regulation rules generally act to resolve the formula operands.

The framework disclosed herein generally provides processing logic that consists, upon submission of operational data or subscription of an operating event, to the following procedure sequence. First, a cost event subscription occurs resolving the cost event role and applicable pattern. Next, a cost object derivation occurs that resolves parent and sub unit cost objects. Next, a formula operand determination is provided and applied to compute magnitude. The next step in the sequence is the application of pattern and document measurements. Next, cost element derivation is resolved for cost classification of contributions. Finally, measurement aggregation is provided.

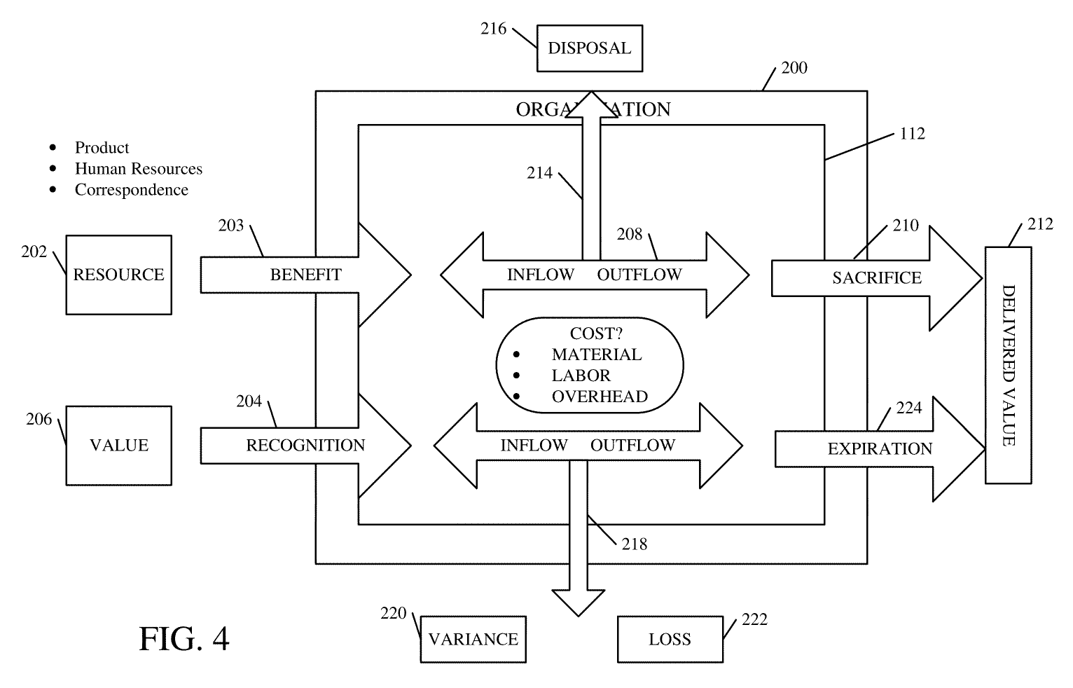

FIG. 4 is a diagrammatic view of the flow of resources and value into and out of an organization 200, modeled in accordance with embodiments described herein. Organization 200 includes or is coupled to cost accounting system 112 that is able to model the beneficial inflow 203 of resources 202 as well as the recognition 204 of value 206. Movement or flow of resources is illustrated diagrammatically at arrow 208 and indicates that resources may flow out via sacrifice 210 to delivered value 212. Additionally, resources 202 may flow out via arrow 214 to disposal 216. Value 206 may flow out, as indicated at reference numeral 218, to variance 220 and/or loss 222. Further, value 206 may flow out via expiration 224 to delivered value 212. Cost accounting system 112 includes objects and elements that model and track the various flows of resources and benefits within, into, and out of organization 200 in accordance with the various policies defined in regulation store 180 (shown in FIG. 3). More particularly, the flow of material costs, labor costs, and overhead costs can be accurately modeled in accordance with various embodiments described herein.

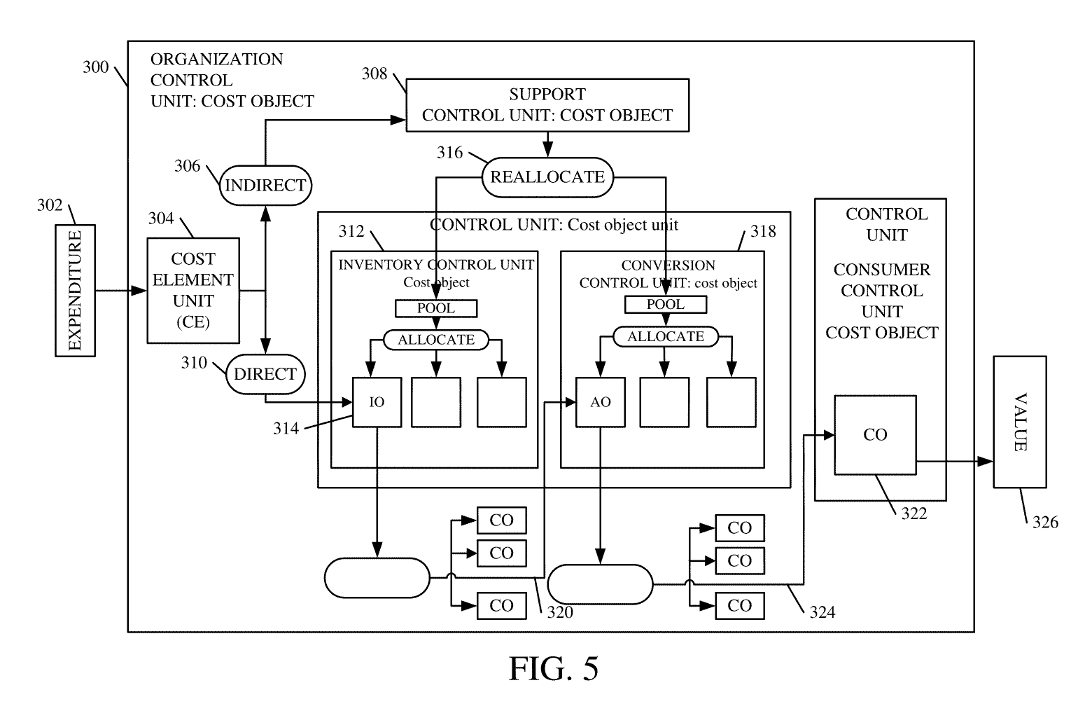

FIG. 5 is a diagrammatic view of an organization's value chain and object definitions in accordance with one embodiment. The organization includes an organization control unit cost object indicated diagrammatically at reference numeral 300. An expenditure 302 flows into cost element unit 304 which may then flow indirectly 306 to support control unit cost object 308. Additionally, cost element unit 304 can flow directly 310 to inventory control unit cost object 312 via IO object 314. Support control unit cost object 308 can reallocate 316 cost flow output to each of inventory control unit cost object 312 and conversion control cost object 318. The flow output from inventory control unit cost object 312 can be provided to conversion control unit cost object 318 as indicated diagrammatically at reference numeral 320. Further, the cost flow output of conversion control unit cost object 318 can be ultimately provided to consumer control unit cost object 322 as indicated diagrammatically at reference numeral 324. Finally, consumer control cost object 322 can provide a cost flow output to value 326. As can be appreciated, defining various objects and cost elements along with suitable policies and patterns can allow embodiments described herein to extensively model virtually any organizational operation and efficiently model the interaction of cost flow within the organization as well as into and out of the organization.

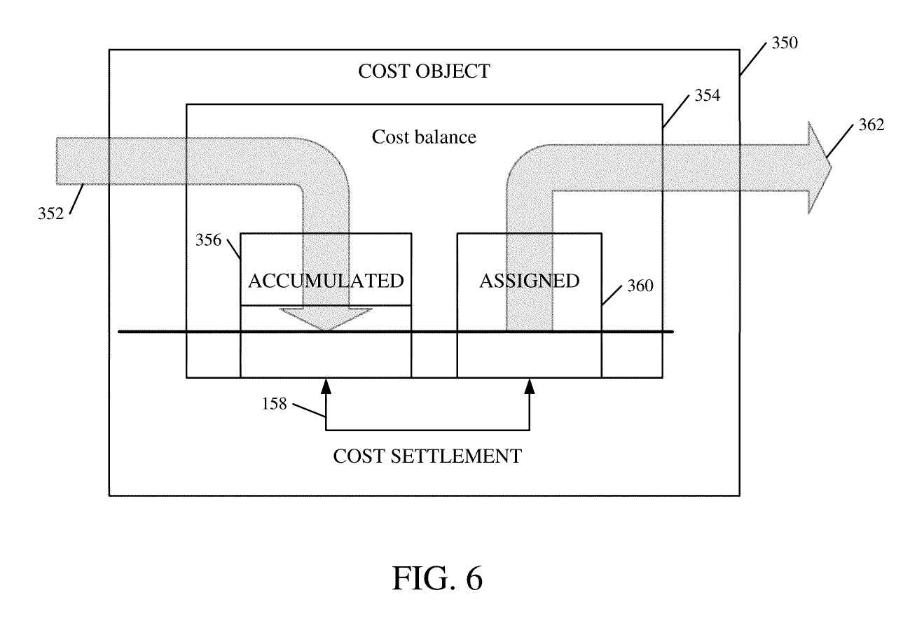

FIG. 6 is a diagrammatic view of cost object balances and settlement in accordance with embodiments described herein. As shown in FIG. 6, cost flows into cost object 350 via arrow 352. In particular, cost flows into cost balances 354 and is accumulated 356 within cost object 350. When a cost settlement occurs, as indicated diagrammatically at reference numeral 358, the cost flows from the accumulated cost balance 356 to an assigned cost balance 360, and subsequently flows out of cost object 350 via arrow 362.

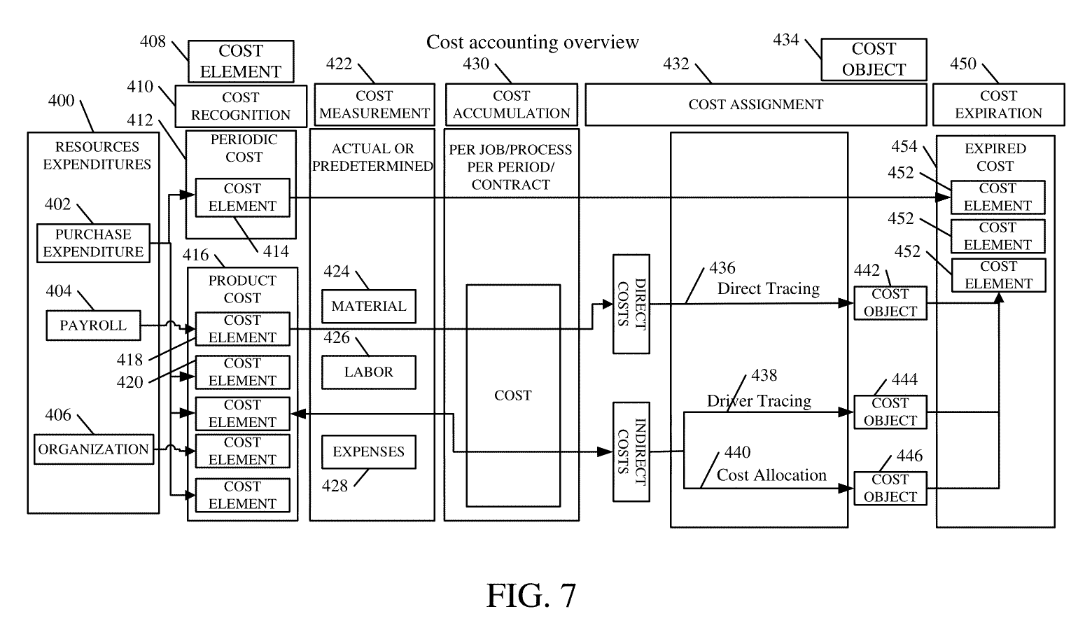

FIG. 7 is a diagrammatic view of a transactional system in accordance with the embodiments described herein modeling a cost accounting system of an organization. As shown in FIG. 7, a number of resources and expenditures are modeled as indicated at block 400. In particular, resources and expenditures 400 include purchase expenditure 402, payroll expenditure 404, and depreciation expenditure 406, for example. Additionally, a number of cost elements 408 are modeled. Cost elements 408 model cost recognition 410. Examples of cost elements include periodic cost 412 having a single cost element 414. Additionally, product cost 416 includes a pair of cost elements 418, 420. As indicated in FIG. 7, cost element 418 is coupled to various resources and expenditures 400 in order to model such resources and expenditures. Cost elements generally flow through cost measurement column 422, which is able to quantify or otherwise measure actual or predetermined costs including materials 424, labor 426, and expenses 428. The costs then flow through cost accumulation column 430 to cost assignment column 432. Cost assignment column 432 includes a number of cost objects 434 that are configured to receive, measure, and direct, cost flow in accordance various embodiments herein. Such cost assignment can include direct tracing 436, driver tracing (for example, ABC costing) 438, and cost allocation 440. The various types of cost assignment flow into cost objects 442, 444, and 446. Ultimately, costs flow from objects 442, 444, 446 to cost expiration column 450. Cost expiration column 450 includes a number of cost elements 452 within expired cost 454.

Embodiments will now be described with respect to a specific example. The example is intended illustrated concepts described herein, and is not intended to be a limiting disclosure.

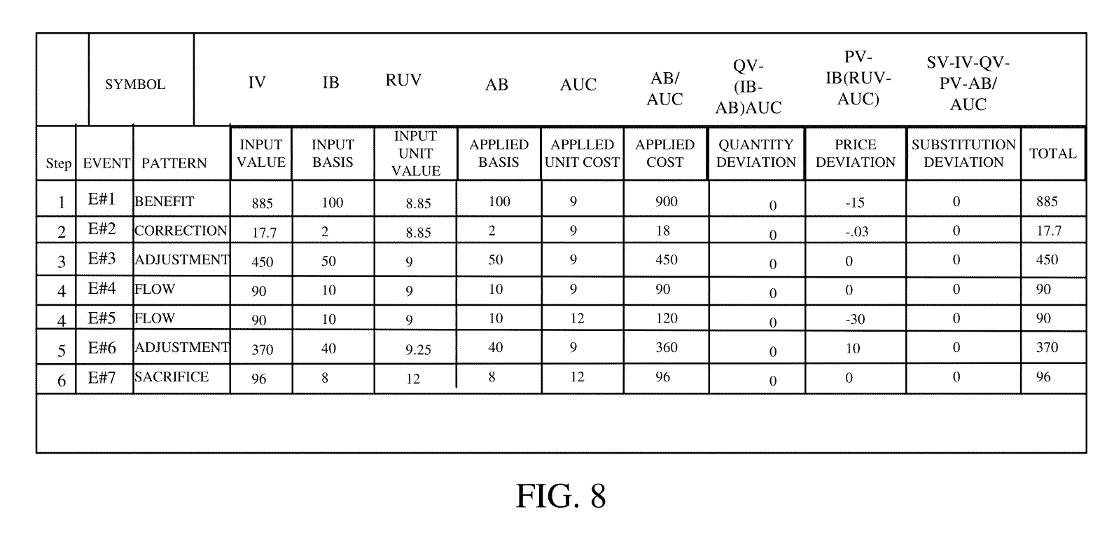

FIG. 8 illustrates a series of operations that are registered in a value chain of an organization from an operational standpoint on an item stored at a warehouse. The cost accounting framework, embodied within a transactional system as described herein, reacts to operational events, subscribing cost events, and measures the cost economic consequences on a cost control and cost classification model scales, applying the framework patterns and formula.

In the example illustrated in FIG. 8, a vendor invoice operation event is raised referencing a matched operation event (product receipt #1) for a quantity of 40 pieces. In response, an adjustment cost event (E#6) is subscribed for the role of adjustment in order to for measure cost resource flow and cost contribution flow according to the adjustment pattern. The relationships identity the event E#1 as being the reconciled event. This, in turn, identifies the concerned cost object and cost flow as CO#2 and CF#1, respectively. CO#2 has a costing method that is set as standard cost in this example, and hence deviation amounts are to be measured with role equaling the expiration and assigned to parent cost object CO#1.

On the cost resource flow, a basis reference is provided from an operational event measurements that indicate that 40 pieces are matched against a product receipt #1 with an initial amount of 100 pieces that is later corrected to 98 pieces. A magnitude of 40 is thus to be reconciled against cost event E#1 whose un-reconciled balance at the time is (48%=100%−52% already reconciled) leaving 48 percent un-reconciled. Accordingly, 40 can be reconciled up to 40 leaving 8 un-reconciled. This gives operand and formula that result as follows: applied basis=40, reconciliation magnitude of 40 percent=40/100, quantity deviation=0.

On the cost flow contribution, an input value is given from an operational event document measurement of 370 to reconcile up to 40 percent against un-reconciled cost flow contribution balance for cost event E#1. The un-reconciled cost flow contribution balance on cost event E#1 is 48 percent of the 900 applied cost. Accordingly, 40% can still be reconciled that represents a magnitude of 360 leaving 8 percent un-reconciled. This gives operand and formula results as follows: input value=370, applied basis=40, applied value=360, price deviation=10.

Embodiments described herein provide a number of features and advantages. For example, modeling cost accounting systems as a system that regulates the cost flow via cost accounting policies and methods of consistent measurement of cost flow for the purpose of cost accounting planned, budgeted, estimated and ultimately realized value chain activities is an important advantage. Further, embodiments described herein generally allow the recording and documenting of the flow of cost and cost resource by measuring the magnitude of cost recognized, flowed into and out of and ultimately expired on multidimensional nominal scales of cost object and cost element units (additionally to quantity and time unit scales). Further still, concepts and methods described herein provide reusable measurement patterns (benefit, inflow/output, sacrifice, adjustment/correction evaluation) for cost accounting the economic consequences of activities in an organization's value chain. Further, embodiments described herein generally provide cost accounting policies that condition the source for the base and value operands to be assigned to a generic formula for computation of magnitudes and cost flow measurements. Another feature of the embodiments described herein is the utilization of applying discrete actual methods conditioned on cost objects and cost element unit levels in the nominal scale, which when applied over the framework patterns, allow the regulation of cost flow to conform to an organization's custom cost accounting system. Still another advantage is provided by flowing cost through any cost object using a systematic mechanism of cost accumulation and cost assignment where ultimately magnitude of the cost assigned is a function of the cost accumulated basis and a cost assignment method. In particular the cost of inventories is provided as a type cost object using an inventory flow assumption. Further, conversion process cost is provided using a joint cost allocation method. Further still, shared cost and overheads use a cost allocation and cost driver method. Finally, the cost for value delivered, be it in the form of goods or services, is modeled allocating cost for expiration.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

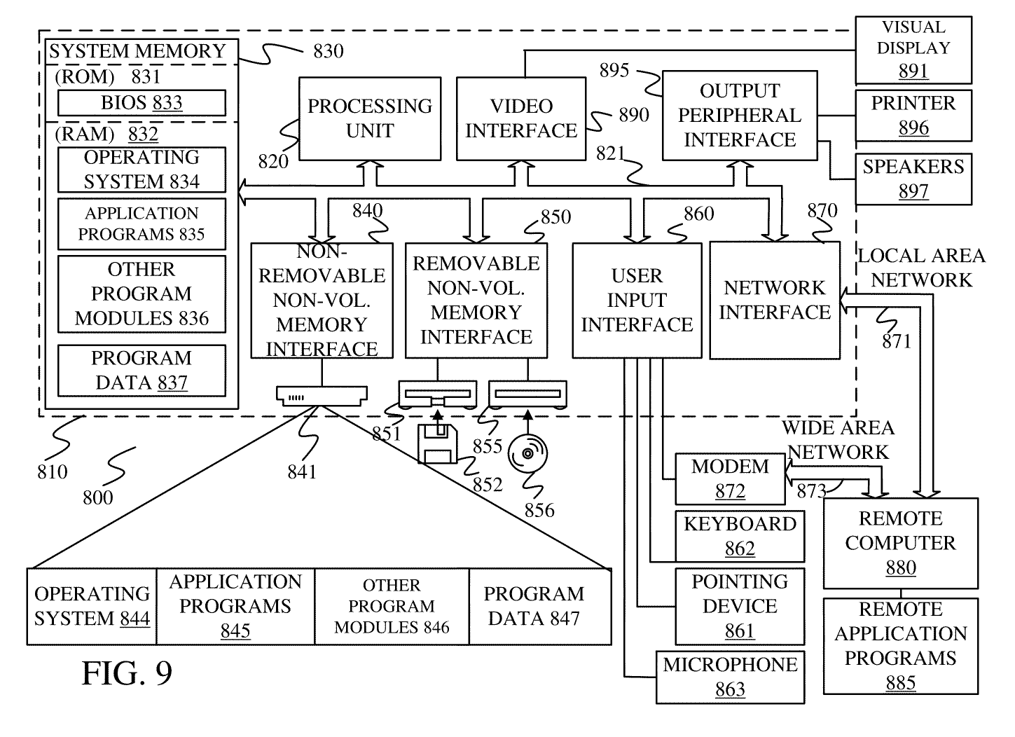

FIG. 9 is a diagrammatic view of a computing environment in which a transactional system can be deployed in accordance with one embodiment. With reference to FIG. 9, an exemplary system for implementing some embodiments includes a general-purpose computing device in the form of a computer 810. Components of computer 810 may include, but are not limited to, a processing unit 820 (which can comprise processor 124, 186 or 190), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to any of the figures can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computer system for modelling transactions is provided that includes a processor a data store coupled to the processor. The data store containing a plurality of cost object models and a plurality of cost elements. The processor is configured to receive an indication of a cost event and flow an aspect of the cost event through at least one cost object stored in the data store.

Example 2 is the computer system of any or all previous examples wherein each cost element provides a classification for a value of cost flow.

Example 3 is the computer system of any or all previous examples wherein each cost element also provides a categorization of cost flow.

Example 4 is the computer system of any or all previous examples wherein the data store contains a policy store that stores a plurality of policies.

Example 5 is the computer system of any or all previous examples wherein each policy is configured to condition and provide methods related to cost element derivation.

Example 6 is the computer system of any or all previous examples wherein each cost element classifies a value of a resource.

Example 7 is the computer system of any or all previous examples wherein at least one cost element is classified to indicate a value of a resource.

Example 8 is the computer system of any or all previous examples wherein at least one cost element is classified to indicate a value lost.

Example 9 is the computer system of any or all previous examples wherein at least one cost element is classified to indicate a value delivered.

Example 10 is the computer system of any or all previous examples wherein each cost object models a segment of a value chain for an organization.

Example 11 is the computer system of any or all previous examples wherein at least one cost object is classified to indicate value flow.

Example 12 is the computer system of any or all previous examples wherein the cost flow is a cost accumulation.

Example 13 is the computer system of any or all previous examples wherein the cost flow is assignment.

Example 14 is the computer system of any or all previous examples wherein at least a portion of the computer system is provided in a cloud implementation.

Example 15 is the computer system of any or all previous examples wherein the transactions are financial transactions.

Example 16 is the computer system of any or all previous examples wherein the transactions are received from at least one source document.

Example 17 is a computer-implemented method of modelling cost flow. The method includes flowing cost into a cost object of a transaction modelling system and accumulating cost within the cost object. The occurrence of a settlement is determined and cost is flowed from the cost object related to the settlement.

Example 18 is the computer-implemented method of any or all previous examples wherein flowing cost into the cost object includes increasing a cost balance value of the cost object.

Example 19 is the computer-implemented method of any or all previous examples wherein flowing cost from the cost object includes subtracting a value from an accumulated cost balance of the cost object.

Example 20 is a computerized cost accounting system including a processor and a data store coupled to the processor. The data store contains a plurality of cost object models and a plurality of cost elements. The processor is configured to model resource flow into and out of an organization using the cost object models and cost elements in accordance with at least one policy stored in the data store.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system for modelling and executing transactions, the computer system comprising:
a processor;
a data store coupled to the processor, the data store containing a plurality of cost object models and a plurality of cost elements; and
wherein the processor is configured to receive an indication of a cost event and flow an aspect of the cost event through at least one cost object stored in the data store.

2. The computer system of claim 1, wherein each cost element provides a classification for a value of cost flow.

3. The computer system of claim 2, wherein each cost element also provides a categorization of cost flow.

4. The computer system of claim 1, wherein the data store contains a policy store that stores a plurality of policies.

5. The computer system of claim 4, wherein each policy is configured to condition and provide methods related to cost element derivation.

6. The computer system of claim 1, wherein each cost element classifies a value of a resource.

7. The computer system of claim 6, wherein at least one cost element is classified to indicate a value of a resource.

8. The computer system of claim 6, wherein at least one cost element is classified to indicate a value lost.

9. The computer system of claim 6, wherein at least one cost element is classified to indicate a value delivered.

10. The computer system of claim 1, wherein each cost object models a segment of a value chain for an organization.

11. The computer system of claim 10, wherein at least one cost object is classified to indicate value flow.

12. The computer system of claim 11, wherein the cost flow is a cost accumulation.

13. The computer system of claim 11, wherein the cost flow is assignment.

14. The computer system of claim 1, wherein at least a portion of the computer system is provided in a cloud implementation.

15. The computer system of claim 1, wherein the transactions are financial transactions.

16. The computer system of claim 1, wherein the transactions are received from at least one source document.

17. A computer-implemented method of modelling and executing cost flow, the method comprising:
flowing cost into a cost object of a transaction modelling system;
accumulating cost within the cost object;
determining the occurrence of a settlement; and
flowing cost from the cost object related to the settlement.

18. The computer-implemented method of claim 17, wherein flowing cost into the cost object includes increasing a cost balance value of the cost object.

19. The computer-implemented method of claim 17, wherein flowing cost from the cost object includes subtracting a value from an accumulated cost balance of the cost object.

20. A computerized cost accounting system comprising:
a processor;
a data store coupled to the processor, the data store containing a plurality of cost object models and a plurality of cost elements; and
wherein the processor is configured to model and execute resource flow into and out of an organization using the cost object models and the cost elements in accordance with at least one policy stored in the data store.
